(19) United States
(12) Patent Application Publication
(10) Pub. No.: US 2026/0200960 A1
(43) Pub. Date: Jul. 16, 2026

(54) REDUCTION OF TRIPHENYLPHOSPHINE OXIDE WITH SPECIFIC CATALYST

(71) Applicant: DSM IP Assets B.V., Maastricht (NL)

(72) Inventors: Fabrice AQUINO, Kaiseraugst (CH); Werner BONRATH, Kaiseraugst (CH); Marius-Sven GOERG, Kaiseraugst (CH)

(21) Appl. No.: 19/134,408

(22) PCT Filed: Dec. 4, 2023
(86) PCT No.: PCT/EP2023/084141

§ 371 Date: May 30, 2025

(30) Foreign Application Priority Data
Dec. 5, 2022 (EP) 22211319.3

(51) Int. Cl. C07F 9/50; B01J 31/14

(52) U.S. Cl. CPC C07F 9/509; B01J 31/146

(57) ABSTRACT

The present invention relates to an improved process for preparing triphenylphosphine (TPP) by reacting triphenylphosphine oxide (TPPO) with a specific catalyst.

The present invention relates to an improved process for preparing triphenylphosphine (TPP) by reacting triphenylphosphine oxide (TPPO) using a specific catalyst and a reducing agent.

TPP, which is the compound of formula (I)

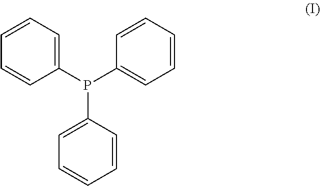 [SMILES: c1ccc(P(c2ccccc2)c2ccccc2)cc1]

is used in industrial scale in the Wittig Ylide synthesis to prepare olefinic compounds such as vitamin A or carotenoids as well as in the Mitsunobu reactions. TPP is used in stoichiometric amounts and is oxidized during these reactions to TPPO, which is the compound of formula (II)

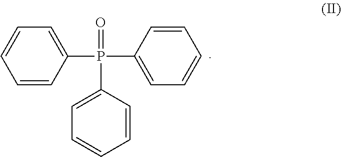 [SMILES: O=P(c1ccccc1)(c1ccccc1)c1ccccc1]

Therefore, a lot of TPPO is produced during these reactions and unfortunately only few uses of TPPO have been disclosed. Since it is an extremely stable substance which can be disposed of only with difficulty, there have been numerous attempts to convert it back into TPP.

One common way to deal with the “TPPO-problem” is to burn the TPPO, so that it can be wasted in a secure way.

Another option is the reduction of TPPO via TPP dichloride to TPP, so that TPP can then be re-used again.

Such recycling processes are known from the prior art, e.g. from EP 638 580 A1, from Heteroatom Chemistry 26(3), 2015, p.199-205.

The recycling processes known from the prior art are using catalysts, which usually comprise a metal atom (such as Ti or Cu). Such metals can cause some problems in the treatment of the waste stream after the recycling process.

Claire Laye et al., Adv. Synth. Catal. 2021, 363, 3035-3043 discloses a reduction of phosphine oxides into the corresponding phosphines using PhSiH₃ as a reducing agent and Ph₃C⁺[B(C₆F₅)₄]⁻ (=Trityl BARF) as an initiator. Trityl BARF is a relative new agent and is very expensive, and, therefore, not suitable for an industrial and commercial use in the reduction of TPPO. Furthermore, it is not or only limited suitable of use in combination with other silanes, particularly with polymethylhydrosiloxane (PMHS).

Surprisingly, it was found in the present invention that the use of a specific catalyst, which does not comprise any metal atom, in combination with a reducing agent, allows to transform TPPO into TPP in an excellent yield.

The catalyst, which is used for the process according to the present invention is the catalyst of formula (III)

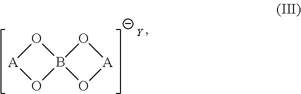

wherein
A is a moiety of formula

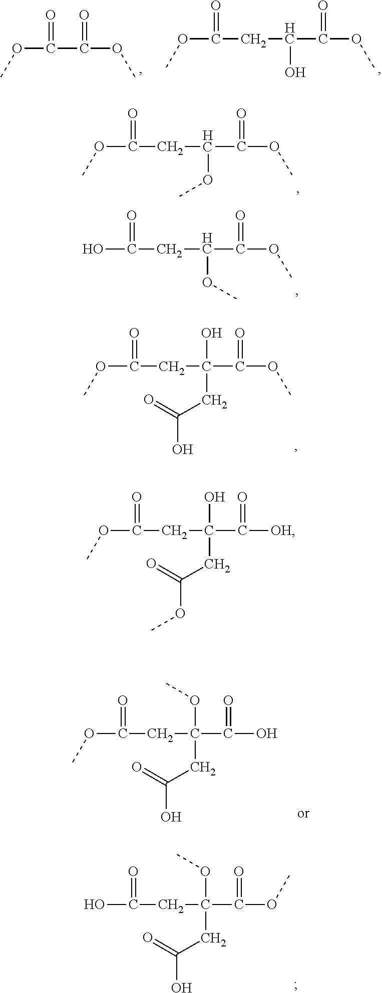

wherein any dotted line represents the bond by which the substituent of formula A is bound to the boron atom,
and
Y is a counterion with a positive charge, which neutralizes the charge of the complex in the bracket.

The nature of Y is not essential for the present invention. Y can be different dependent on the synthesis of the compound of formula (III).

The catalysts of the formula (III) are esters of boric acid and form spiro compounds having boron-oxygen bonds.

The catalysts (compounds of formula (III)), which are used in the process according to the present invention can be produced according to methods disclosed in the prior art (WO 02/068433 A1 or U.S. Pat. No. 5,886,196).

In the present document, any dotted line in formulae represents the bond by which a substituent is bound to the rest of a molecule.

The process according to the present invention is carried out in the presence of at least one siloxane and/or silane.

Therefore, the present invention relates to the process (P) for producing triphenylphosphine (compound of the formula (I))

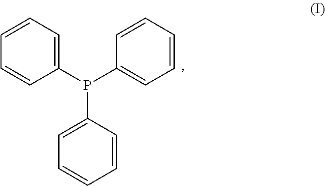 [SMILES: c1ccc(P(c2ccccc2)c2ccccc2)cc1]

wherein triphenylphosphine oxide (the compound of formula (II))

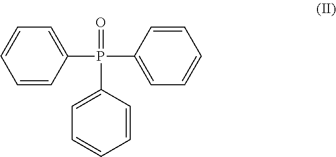 [SMILES: O=P(c1ccccc1)(c1ccccc1)c1ccccc1]

is reacted with at least one siloxane and/or at least one silane
in the presence of at least one catalyst of formula (III)

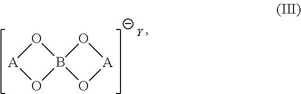

wherein
A is a moiety of formula

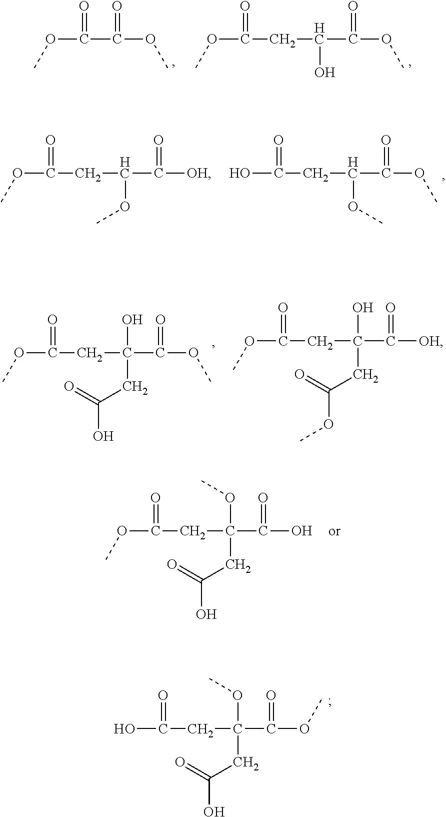

wherein any dotted line represents the bond by which the substituent of formula A is bound to the boron atom,
and
Y is a counterion with a positive charge, which neutralizes the charge of the complex in the bracket.

Particularly suitable siloxanes are those of formula (IV)

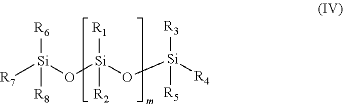

wherein
R₁, R₂, R₃, R₄, R₅, R₅, R₇ and R₃ are independently from each other H or a C₁-C₄-alkyl, and
m is a value from 0 to 100,000;
with the proviso that at least one of the substituents R₁, R₂, R₃, R₄, R₅, R₅, R₇ or R₃ is H.

Preferred siloxanes are those of formula (IV), wherein R₁, R₂, R₃, R₄, R₅, R₆, R₇ and R₃ are independently from each other H or a C₁-C₂-alkyl, and
m is a value from 0 to 100,000
with the proviso that at least one of the substituents R₁, R₂, R₃, R₄, R₅, R₅, R₇ or R₃ is H.

It is preferred that R₁=H.

Particularly, it is preferred that R₁=H and R₂=R₃=R₄=R₅=R₆=R₇=R₃, preferably R₂=R₃=R₄=R₅=R₆=R₇=R₃=ethyl or methyl, preferably methyl.

More preferred siloxanes are those of the following formulae (IV′) and (IV″)

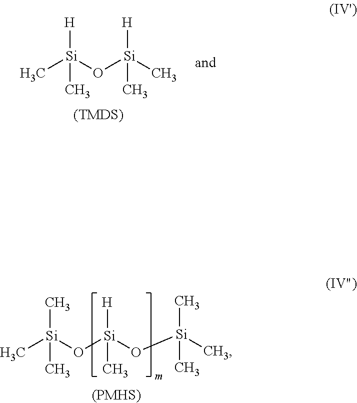

wherein
m is a value between 2 and 100,000.

Preferably m is a value from 2-20,000, more preferably m is a value from 2-12,000, most preferably m is a value from 2-10,000).

Most preferred siloxane is the siloxane of the formula (IV″).

Particularly suitable silanes are those compounds of formula (Va) or (Vb) or (Vc).

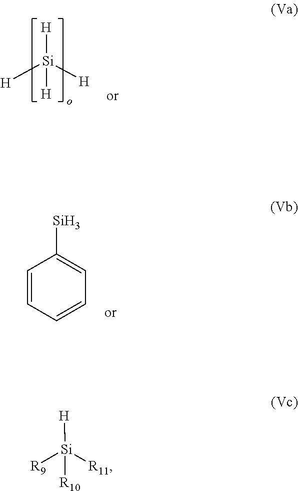

wherein
is a value from 3 to 10;
and R₉, R₁₀ and R₁₁ are independently from each other H or a C₁-C₆-alkyl or a OC₁-C₆-alkyl or a phenyl group, with the proviso that at least one of the substituents R₉, R₁₀ and R₁₁ is different from H.

Particularly preferred silanes of formula (Vc) are silanes of the formula (Vc′) or (Vc″) or (Vc′″) or (Vc″″), preferably (Vc′) or (Vc″).

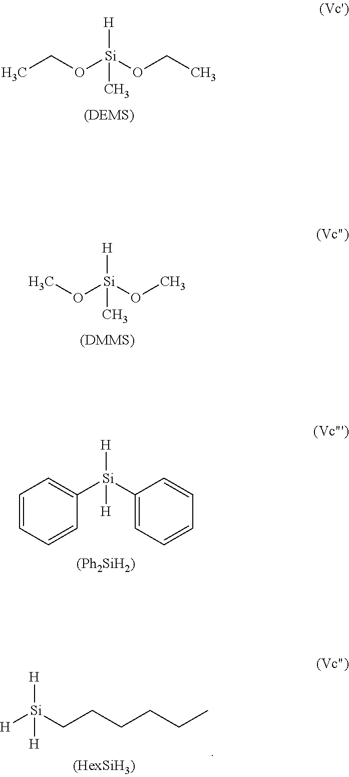

The silanes of formula (Vb) and (Vc′) and (Vc″) are the most preferred silanes.

Therefore, the present invention also relates to a process (P1), which is process (P), wherein the at least one siloxane is chosen from the group having the formula (IV)

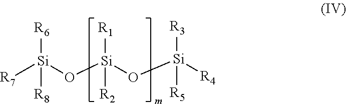

wherein
R₁, R₂, R₃, R₄, R₅, R₆, R₇ and R₃ are independently from each other H or a C₁-C₄-alkyl, and
m is a value from 0 to 100,000;
with the proviso that at least one of the substituents R₁, R₂, R₃, R₄, R₅, R₅, R₇ or R₃ is H.

Therefore, the present invention also relates to a process (P1′), which is process (P1), wherein the at least one siloxane is chosen from the group having the formula (IV), wherein R₁, R₂, R₃, R₄, R₅, R₆, R₇ and R₃ are independently from each other H or a C₁-C₂-alkyl, and
m is a value from 0 to 100,000;
with the proviso that at least one of the substituents R₁, R₂, R₃, R₄, R₅, R₅, R₇ or R₃ is H.

Therefore, the present invention also relates to a process (P1″), which is process (P1), wherein the at least one siloxane is chosen from the group consisting of

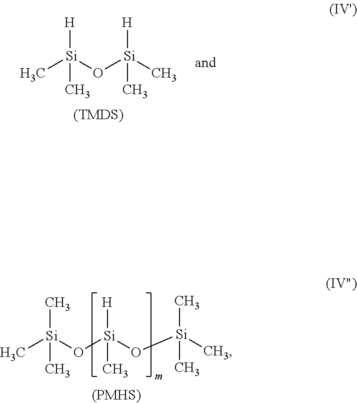

wherein
m is a value between 10 and 100,000 (preferably m is a value from 100-20,000, more preferably m is a value from 1000-12,000, most preferably m is a value from 1000-10,000).

Therefore, the present invention also relates to a process (P2), which is process (P1), (P1′) or (P1″), wherein the at least one silane is chosen from the group having the formula (Va) and (Vb) and (Vc)

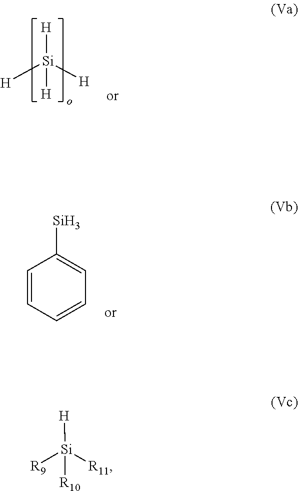

wherein
is a value from 3 to 10;
and R₉, R₁₀ and R₁₁ are independently from each other H or a C₁-C₆-alkyl or a OC₁-C₆-alkyl or a phenyl group, with the proviso that at least one of the substituents R₉, R₁₀ and R₁₁ is different from H.

Therefore, the present invention also relates to a process (P2′), which is process (P1), (P1′) or (P1″), wherein the at least one silane is the silane of formula (Vb)

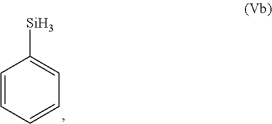

In the process according to the present invention, the at least one siloxane and/or the at least one silane is usually and preferably used in an amount of 1-10 mol-%, preferably 2-8 mol-%, in regard to the compound of formula (II).

Therefore, the present invention also relates to a process (P3), which is process (P1), (P1′), (P1″), (P2) or (P2′), wherein the at least one siloxane and/or the at least one silane is used in an amount of 1-10 mol-%, in regard to the compound of formula (II).

Therefore, the present invention also relates to a process (P3′), which is process (P1), (P1′), (P1″), (P2) or (P2′), wherein the at least one siloxane and/or the at least one silane is used in an amount of 2-8 mol-%, in regard to the compound of formula (II).

The process according to the present invention is carried out in the presence of at least one catalyst of formula (III).

The catalyst can be added as such (as shown in formula (III)).

Alternatively, it can be produced in situ during the process. This mean that the catalyst of formula (III) is formed in the reaction mixture by adding the starting material to form the catalyst in the reaction mixture (as in U.S. Pat. No. 5,886,196).

This means that, instead of the compound of formula (III), it is possible to add oxalic acid or malic acid (=2-hydroxysuccinic acid) or citric acid and boric acid (or B₂O₃, B(OCH₃)₃ or trimethylboroxine) to the reaction mixture. Oxalic acid or malic acid or citric acid and boric acid (or B₂O₃, B(OCH₃)₃ ortrimethylboroxine) are added to the reaction mixture preferably in a molar ratio of 2:1 (oxalic acid or malic acid or citric acid:boric acid).

Therefore, the present invention also relates to a process (P4), which is process (P1), (P1′), (P1″), (P2), (P2′), (P3) or (P3′), wherein the catalyst can be added as such (as shown in formula (III)).

Therefore, the present invention also relates to a process (P5), which is process (P1), (P1′), (P1″), (P2), (P2′), (P3) or (P3′), wherein the catalyst is formed in situ in the reaction mixture.

Therefore, the present invention also relates to a process (P5′), which is process (P5), wherein oxalic acid or malic acid or citric acid and boric acid (or B₂O₃, B(OCH₃)₃ or trimethylboroxine) are added to the reaction mixture in a molar ratio of 2:1 (oxalic acid or malic acid or citric acid:boric acid).

In the process according to the present invention, the catalyst (either used as such or produced in situ) is usually and preferably used in an amount of 0.01-1 mol-%, preferably 0.05-0.8 mol-%, in regard to the compound of formula (II).

Therefore, the present invention also relates to a process (P6), which is process (P1), (P1′), (P1″), (P2), (P2′), (P3), (P3′), (P4), (P5) or (P5′), wherein the catalyst (either used as such or produced in situ) is used in an amount of 0.01-1 mol-%, in regard to the compound of formula (II).

Therefore, the present invention also relates to a process (P6′), which is process (P1), (P1′), (P1″), (P2), (P2′), (P3), (P3′), (P4), (P5) or (P5′), wherein the catalyst (either used as such or produced in situ) is used in an amount of 0.05-0.8 mol-%, in regard to the compound of formula (II).

The process according to the present invention is usually and preferably carried out in at least one inert solvent.

The solvent used in the process according to the present invention is preferably at least one aromatic solvent, ether, carbonates, and/or at least one alkane.

Suitable and preferred aromatic solvents are benzene, benzene substituted with one or more C₁-C₄-alkyl or benzene substituted with one or more OC₁-C₄-alkyl group.

More preferred aromatic solvents are i.e. toluene, mesitylene, xylene and anisol. A very preferred aromatic solvents are mixture of aromatic compounds commercially under the trademark Solvesso™, particularly Solvesso™ 100, from Exxon Mobil.

Suitable ethers are tetrahydrofuran (THF), 2-methyltetrahydrofuran (2-MeTHF) or cyclopentyl methyl ether (CPME). The preferred solvent is cyclopentyl methyl ether (CPME).

Suitable alkanes are C₄-C₁₃-alkanes, which can be linear, branched or cyclic.

Particular suitable alkanes are hexane, heptane, octane, pentane, decane, undecane, dodecane, or any mixture of alkanes (such as i.e. Isopar M).

Therefore, the present invention also relates to a process (P7), which is process (P1), (P1′), (P1″), (P2), (P2′), (P3), (P3′), (P4), (P5), (P5′), (P6) or (P6′), wherein the process is carried out in at least one inert solvent.

Therefore, the present invention also relates to a process (P7′), which is process (P7), wherein the solvent is chosen from the group consisting of aromatic solvents, ethers, carbonates and alkanes.

Therefore, the present invention also relates to a process (P7″), which is process (P7), wherein the solvent is chosen from the group consisting of benzene, benzene substituted with one or more C₁-C₄-alkyl and benzene substituted with one or more OC₁-C₄-alkyl group.

Therefore, the present invention also relates to a process (P7′″), which is process (P7″), wherein the solvent is chosen from the group consisting of toluene, mesitylene, xylene and anisol.

Therefore, the present invention also relates to a process (P7″″), which is process (P7), wherein the solvent is chosen from the group consisting of tetrahydrofuran (THF), 2-methyltetrahydrofuran (2-MeTHF) or cyclopentyl methyl ether (CPME).

Therefore, the present invention also relates to a process (P7′″″), which is process (P7), wherein the solvent is chosen from the group consisting of C₄-C₁₈-alkanes, which can be linear, branched or cyclic.

Therefore, the present invention also relates to a process (P7″″″), which is process (P7′″″), wherein the solvent is chosen from the group consisting of hexane, heptane, octane, pentane, decane, undecane, dodecane, or any mixture of alkanes (such as i.e. Isopar M).

The process according to the present invention is usually and preferably carried out at elevated temperature. Preferably, the process according to the present invention is carried out at a temperature of 80° C. to 200° C., more preferably at 90° C. to 180° C.

Therefore, the present invention also relates to a process (P8), which is process (P1), (P1′), (P1″), (P2), (P2′), (P3), (P3′), (P4), (P5), (P5′), (P6), (P6′), (P7), (P7′), (P7″), (P7′″), (P7″″), (P7′″″) or (P7′″″″), wherein the process is carried out at a temperature of 80° C. to 200° C.

Therefore, the present invention also relates to a process (P8′), which is process (P1), (P1′), (P1″), (P2), (P2′), (P3), (P3′), (P4), (P5), (P5′), (P6), (P6′), (P7), (P7′), (P7″), (P7′″), (P7″″), (P7′″″) or (P7″″″), wherein the process is carried out at a temperature of 90° C. to 180° C.

The reaction time of the process according to the present invention is usually several hours. Usually and preferably the reaction time of the process according to the present invention is 3 to 30 hours.

Therefore, the present invention also relates to a process (P9), which is process (P1), (P1′), (P1″), (P2), (P2′), (P3), (P3′), (P4), (P5), (P5′), (P6), (P6′), (P7), (P7′), (P7″), (P7′″), (P7″″), (P7′″″), (P7″″″), (P8) or (P8′), wherein the reaction time is 3 to 30 hours.

After the process the reaction product (compound of formula (I)) is isolated using commonly known methods. The reaction product can also be purified (when needed) using commonly known methods.

### EXAMPLES

The following examples illustrate the invention.

### Example 1

Triphenylphosphine oxide (2.84 g, 10.0 mmol) was placed in a 100 mL flask and CPME (50.0 ml, 99.9%, contains 50 ppm BHT as inhibitor) was added. Oxalic acid (182.07 mg, 2.002 mmol) and boric acid (61.96 mg, 1.000 mmol) were added, and the mixture was stirred at 24° C. for 10 min followed by addition of PMHS (6.5 g, 6.5 ml, 2.6 eq, 26 mmol). The mixture was heated to 105° C. for 21 h and analyzed by GC. After phase separation, the organic phase was washed with sat. aq. NaHCO₃.

The reaction mixture was concentrated under reduced pressure (40° C., 10 mbar) resulting in approx. 5 mL oily residue. The oily suspension was diluted with 2-propanol (25 mL) and heated to 80° C. for 1 h resulting in a clear solution. The reaction mixture was cooled to 25° C. and then cooled to 0° C. for 1 hour. Afterwards, the solution was cooled to −10° C. for 1 hour. The resulting precipitate was isolated by filtration, washed with 2-propanol (10 mL), dried under vacuo, and the resulting colorless crystals (1.35 g) were analyzed by GC. The mother liquor was cooled to −20° C. and the precipitated crystals were isolated by filtration and washed with cold 2-propanol (5 mL). The solid was dried under vacuo and the resulting colorless crystals (0.83 g) were analyzed by GC. The product triphenylphosphine was obtained as colorless crystals (2.18 g, after GC analysis: 1.89 g, 72%).

Additional experiments are summarized in the following table. The same reactions conditions are used as in Example 1 when not otherwise listed in the table 1.

TABLE 1
TPPO reduction experiments in presence
of silanes or siloxanes and catalyst

| | | | | catalyst | | TPP/TPPO |
|---|---|---|---|---|---|---|
| | Siloxane/ | | | amount | T | content |
| Exp. | Silane | Eq. | solvent | [mol-%] | [° C.] | (GC area %) |
| 2 | TMDS | 3.0 | Toluene | 20 | 110 | 96/4 |
| 3 | DMMS | 3.0 | Toluene | 20 | 110 | 73/27 |
| 4 | DEMS | 3.0 | Toluene | 20 | 110 | 82/18 |
| 5 | PMHS | 2.0 | Solvesso 100 | 20 | 140 | 98/2 |
| 6 | PMHS | 2.0 | CPME | 20 | 105 | 92/8 |
| 7 | PhSiH₃ | 1.1 | CPME | 20 | 105 | 91/9 |
| 8 | PMHS | 2.6 | CPME | 10 | 105 | 97/3 |
| 9 | TMDS | 2.5 | CPME | 10 | 105 | 80/20 |
| 10 | PMHS | 2.6 | CPME | 5 | 105 | 87/13 |

### Example 11

Triphenylphosphine oxide (2.85 g, 10.0 mmol) was placed in a 100 mL sulfonation flask and CPME (50.0 mL, 99.9%, contains 50 ppm BHT as inhibitor), boric acid (30.97 mg, 498.4 μmol) and (S)-2-hydroxysuccinic acid (134.94 mg, 996.28 μmol) were added. The reaction mixture was stirred for 10 min and PMHS (6.5 g, 6.5 mL, 26 mmol) was added. The mixture was heated to 105° C. for 21 h and analyzed by GC (A sample was taken and mixed with aq. KOH (42%). After phase separation, the organic phase was washed with sat. NaHCO₃, diluted with ethyl acetate, filtered and analyzed by GC).

The reaction mixture was concentrated under reduced pressure (40° C., 10 mbar) resulting in a colorless, oily suspension (9.43 g). The residue was diluted with 2-propanol (5 mL) and heated to 80° C. for 5 min resulting in a clear solution. The reaction mixture was cooled to 25° C. within 1 h and then cooled to 0° C. for 30 min. The resulting precipitate was isolated by filtration, washed with 2-propanol (4 mL, 0° C.), dried under vacuo for 1 h, and the resulting colorless crystals (2.42 g) were analyzed by GC (solvent:ethyl acetate). The mother liquor was cooled to 0° C. for 10 min and the precipitated crystals were isolated by filtration and washed with 2-propanol (2 mL, 0° C.). The solid was dried under vacuo and the resulting colorless crystals (0.21 g) were analyzed by GC. The product triphenyl-phosphine was obtained as colorless crystals (2.63 g, after GC analysis: 2.50 g, 95%).

### Example 12

Triphenylphosphine oxide (2.84 g, 10.0 mmol) was placed in a 100 mL sulfonation flask and CPME (50.0 mL, 99.9%, contains 50 ppm BHT as inhibitor), boric acid (31.07 mg, 500.0 μmol) and citric acid (192.98 mg, 999.45 μmol) were added. The reaction mixture was stirred for 10 min and PMHS (6.5 g, 6.5 mL, 2.6 Eq, 26 mmol) was added. The mixture was heated to 105° C. for 21 h and analyzed by GC. (A sample was taken and mixed with aq. KOH (42%). After phase separation, the organic phase was washed with sat. NaHCO₃, concentrated with rotavapor (40° C., 10 mbar) and diluted with ethyl acetate, filtered and analyzed by GC).

The reaction mixture was concentrated under reduced pressure (40° C., 10 mbar) resulting in a colorless, oily suspension (9.0 g). The residue was diluted with 2-propanol (6.4 mL) and heated to 70° C. for 15 min resulting in a clear solution. The reaction mixture was cooled to 40° C. within 30 min and then cooled to 0° C. for 15 min. The resulting precipitate was isolated by filtration, washed with 2-propanol (3×10 mL, 0° C.), dried under vacuo for 1 h, and the resulting colorless crystals (1.70 g) were analyzed by GC (solvent:ethyl acetate). The mother liquor was cooled to 0° C. for 30 min and the precipitated crystals were isolated by filtration, dried under vacuo and the resulting colorless crystals (0.1 g) were analyzed by GC. The product triphenylphosphine was obtained as colorless crystals (1.8 g, after GC analysis: 1.70 g, 65%).

1. A process for producing triphenylphosphine (compound of formula (I)) 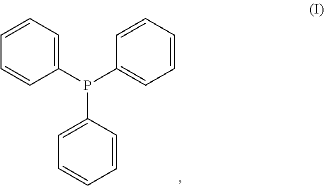 [SMILES: c1ccc(P(c2ccccc2)c2ccccc2)cc1]
wherein triphenylphosphine oxide (the compound of formula (II)) 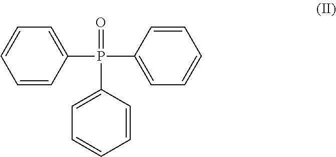 [SMILES: O=P(c1ccccc1)(c1ccccc1)c1ccccc1]
is reacted with at least one siloxane and/or at least one silane
in the presence of at least one catalyst of formula (III) 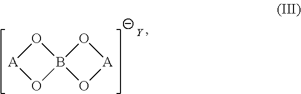
wherein
A is a moiety of formula 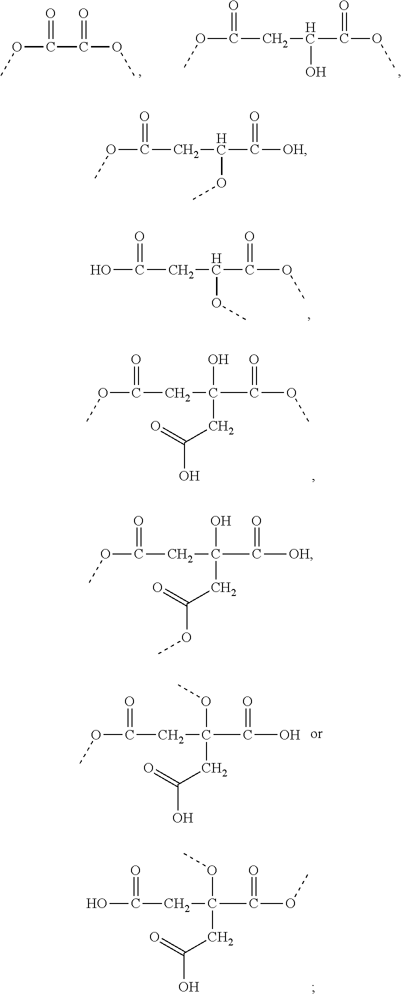
wherein any dotted line represents the bond by which the substituent of formula A is bound to the boron atom,
and
Y is a counterion with a positive charge, which neutralizes the charge of the complex in the bracket.

2. Process according to claim 1, wherein the at least one siloxane is chosen from the group of siloxanes having the formula (IV) 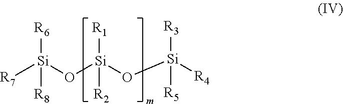
wherein
R₁, R₂, R₃, R₄, R₅, R₆, R₇ and R₈ are independently from each other H or a C₁-C₄-alkyl, and
m is a value from 0 to 100,000;
with the proviso that at least one of the substituents R₁, R₂, R₃, R₄, R₅, R₆, R₇ or R₈ is H.

3. Process according to claim 1, wherein the at least one siloxane is chosen from the group consisting of 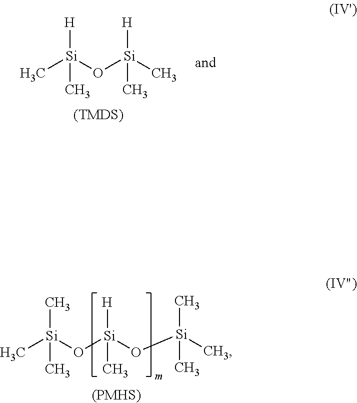
wherein
m is a value between 2 and 100,000, preferably m is a value from 2-20,000, more preferably m is a value from 2-12,000, most preferably m is a value from 2-10,000.

4. Process according to claim 1, wherein the at least one silane is chosen from the group having the formula (Va) and (Vb) or (Vc) 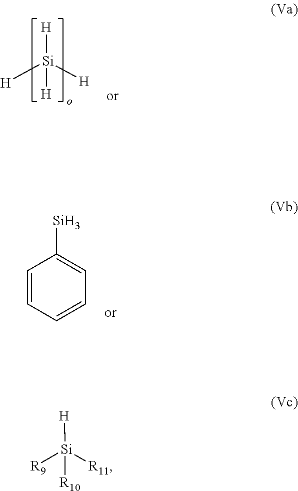
wherein
is a value from 3 to 10
and R₉, R₁₀ and R₁₁ are independently from each other H or a C₁-C₆-alkyl or a OC₁-C₆-alkyl or a phenyl group, with the proviso that at least one of the substituents R₉, R₁₀ and R₁₁ is different from H.

5. Process according to claim 4, wherein the silane of the formula (Vc) is a silane of the (Vc′) or (Vc″) or (Vc′″) or (Vc″″), preferably (Vc′) or (Vc″)

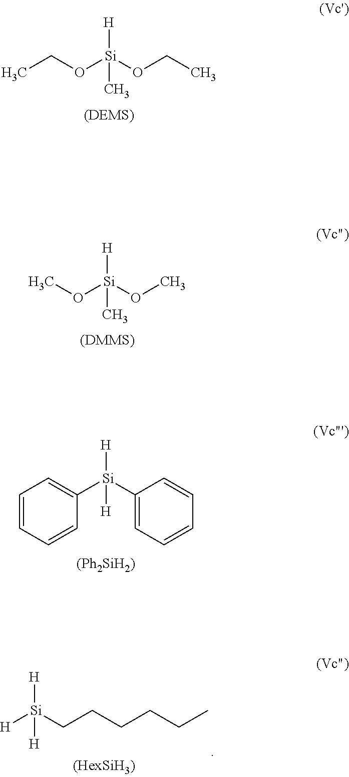

6. Process according to claim 1, wherein the at least one siloxane and/or the at least one silane is used in an amount of 1-10 mol-%, preferably 2-8 mol-%, in regard to the compound of formula (II).

7. Process according to claim 1, wherein the catalyst can be added as such.

8. Process according to claim 1, wherein the catalyst is formed in situ in the reaction mixture.

9. Process according to claim 7, wherein oxalic acid or malic acid or citric acid and boric acid (or B₂O₃, B(OCH₃)₃ or trimethylboroxine) are added to the reaction mixture in a molar ratio of 2:1 (oxalic acid or malic acid or citric acid:boric acid).

10. Process according to claim 1, wherein the catalyst (either used as such or produced in situ) is used in an amount of 0.01-1 mol-%, in regard to the compound of formula (II).

11. Process according to claim 1, wherein the process is carried out in at least one inert solvent.

12. Process according to claim 11, wherein the solvent is chosen from the group consisting of aromatic solvents, ethers, carbonates and alkanes.

13. Process according to claim 1, wherein the process is carried out at a temperature of 80° C. to 200° C.
